(19) United States
(12) Patent Application Publication
(10) Pub. No.: US 2018/0173377 A1
(43) Pub. Date: Jun. 21, 2018

(54) CONDENSED COMMUNICATION CHAIN CONTROL SURFACING

(71) Applicant: Microsoft Technology Licensing, LLC, Redmond, WA (US)

(72) Inventors: Yingying Geng, Seattle, WA (US); Jose Alberto Rodriguez, Seattle, WA (US); Vivian Hsu, Seattle, WA (US); Casey James Baker, Seattle, WA (US); Chad Aron Voss, Seattle, WA (US)

(73) Assignee: Microsoft Technology Licensing, LLC, Redmond, WA (US)

(21) Appl. No.: 15/381,042

(22) Filed: Dec. 15, 2016

(51) Int. Cl. G06F 3/0482; G06F 3/0485; G06F 3/0481; H04L 12/58

(52) U.S. Cl. CPC G06F 3/0482; G06F 3/0485; H04L 51/08; H04L 51/16; G06F 3/04817

(57) ABSTRACT

Surfacing details of a condensed electronic conversation allows for the more efficient use of the condensed from of that electronic conversation. Important comments, attached documents, and other content items included in the condensed electronic conversation are provided in a control interface of the condensed electronic conversation that provide a user with details on those surfaced content items without expanding the display of the conversation. Elements representing the content items in the control interface are actuatable to, in various aspects, navigate to a relevant portion of the condensed electronic conversation, save the content item, or launch an application to view the content item.

### BACKGROUND

Several forms of electronic communication that include multiple messages or replies may be condensed to save space on a user's viewing device. For example, a chain of emails may be condensed to only show the latest reply. In another example, a forum thread may be condensed to only show the initial post and the latest post.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

Systems and methods are provided in the present disclosure to surface important details from a condensed chain of communications and to enable a user to interact with elements in the chain more naturally. In response to condensing a communication chain, a control interface is surfaced that highlights important features of that communication chain, including attached documents and designated communications, which may be displayed as elements including icons, thumbnails, and previews. The elements of the control enable users to gain additional information about the important features of the communication chain that they represent. For example, a user hovering over an element may be provided with a file name, a preview, metadata about an attachment, or the like. In another example, a user clicking on an element may navigate to the collapsed communication associated with the element, open a document associated with the element, save the file to a new location, or the like.

The present disclosure improves the functionality of the computing devices on which it is practiced by, among other benefits, reducing the use of processing and memory resources in searching condensed communication chains and improving the use of display device real estate. For example, by surfacing element related to attachments (and other key features of a collapsed chain), the user does not need to request the expansion of the condensed communication chain to locate and examine various attachments at various positions in the chain; reducing the use of computing resources. In another example, by displaying the control with a condensed chain, more information may be provided in a given display area; improving the use of display device real estate.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 illustrates an example environment in which the present disclosure may be practiced to surface content items from a condensed chain of electronic communications;

FIGS. 2A-2F illustrate example displays of conversation chains;

FIG. 3 is a flow chart showing general stages involved in an example method for surfacing details from a condensed chain of communications;

FIG. 4 is a block diagram illustrating example physical components of a computing device; and

FIGS. 5A and 5B are block diagrams of a mobile computing device.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

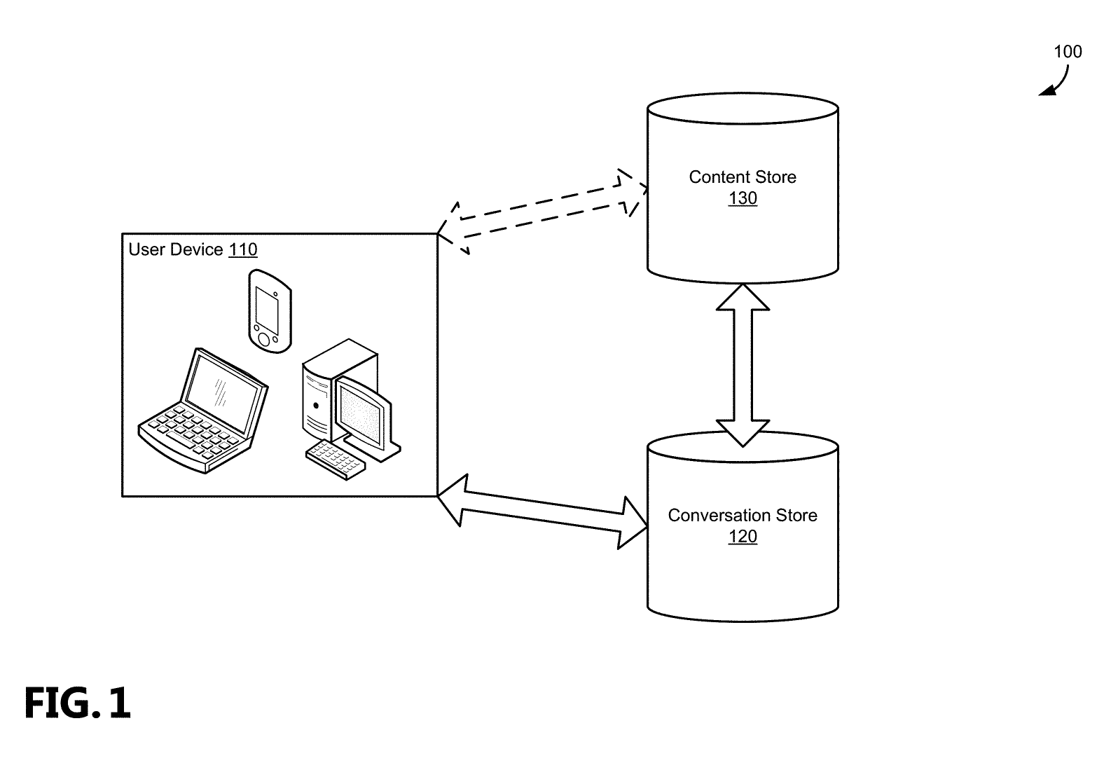

FIG. 1 illustrates an example environment 100 in which the present disclosure may be practiced to surface content items from a condensed chain of electronic communications. A user device 110, on which the electronics communications are displayed, is in communication with a conversation store 120, in which the electronic communications are stored in conversation groups. In various aspects, a conversation group may be displayed in an expanded state or a condensed state; attempting to show (according to the available display space) each of the component communications in the conversation's chain or a representative subset thereof. The conversation store 120 is also in communication with a content store 130, which stores various content items that have been included in the chain of communications for access by the user device 110 via the conversation.

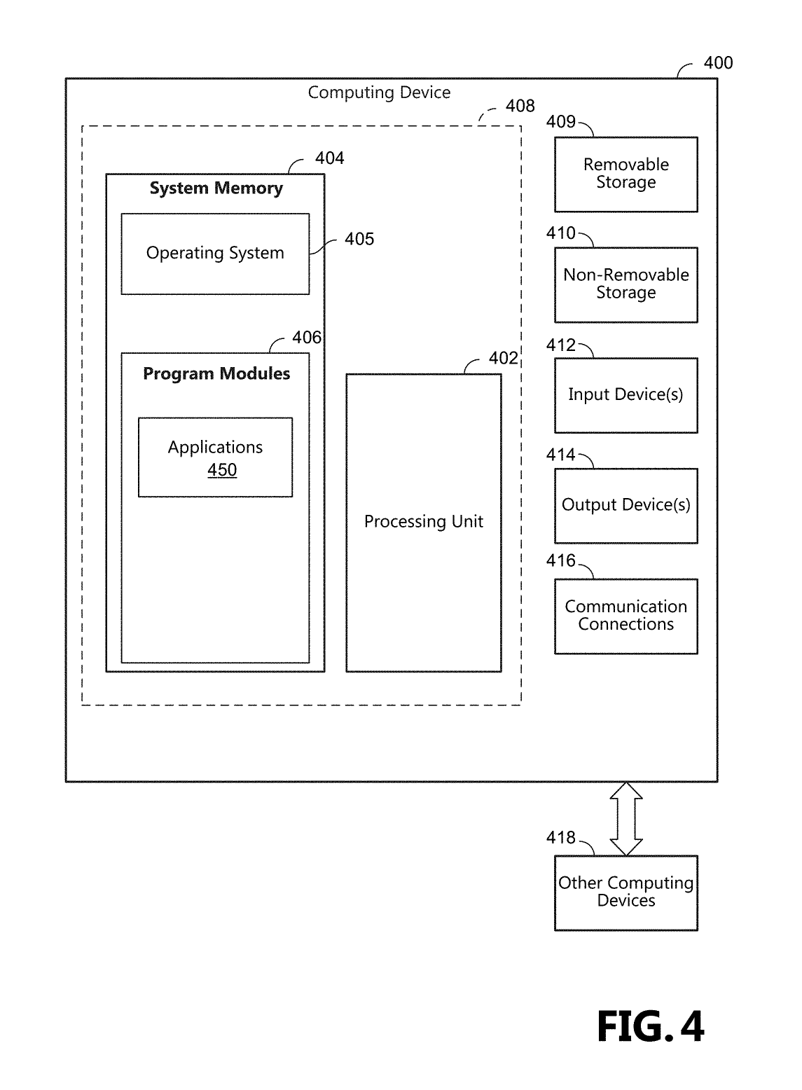

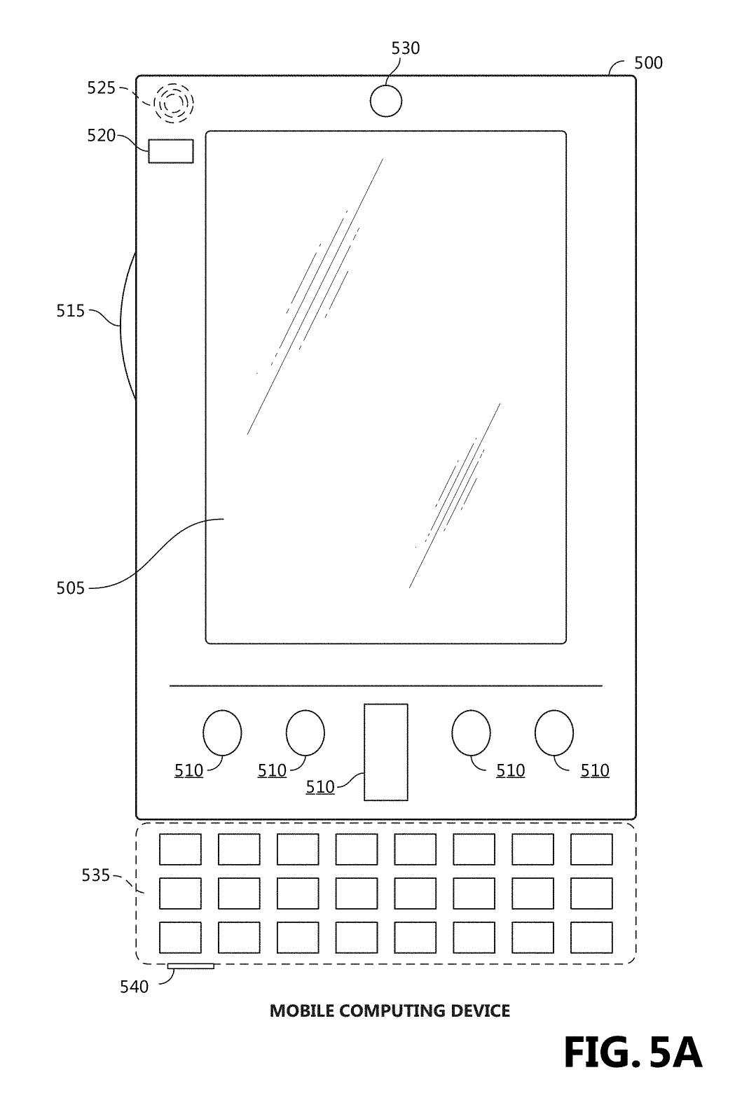

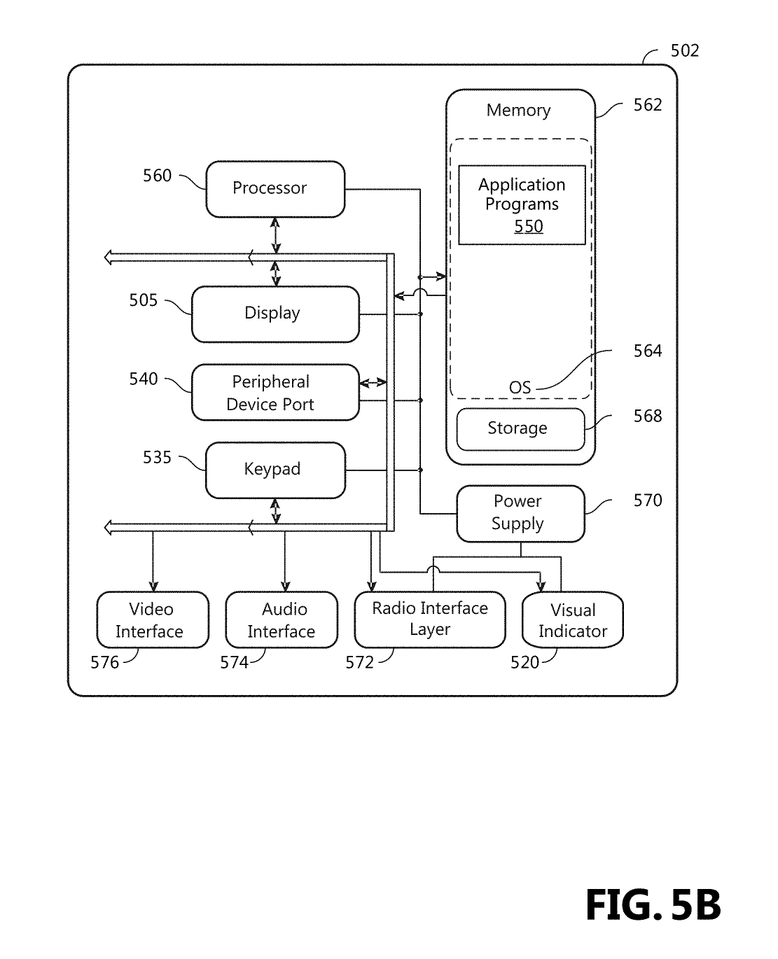

The user device 110, conversation store 120, and content store 130 are illustrative of a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, printers, and mainframe computers. The hardware of these computing systems is discussed in greater detail in regard to FIGS. 4-5B.

While the user device 110, conversation store 120, and content store 130 are shown remotely from one another for illustrative purposes, it should be noted that several configurations of one or more of these devices hosted locally to another illustrated device are possible (e.g., the conversation store 120 and/or the content store 130 are storage devices that are part of the user device 110). It will also be appreciated that each illustrated device may represent multiple instances of that device (e.g., the user device 110 may represent multiple devices in communication with one conversation store 120). Various servers and intermediaries familiar to those of ordinary skill in the art may lie between the component systems illustrated in FIG. 1 to route the communications between those systems, which are not illustrated so as not to distract from the novel aspects of the present disclosure.

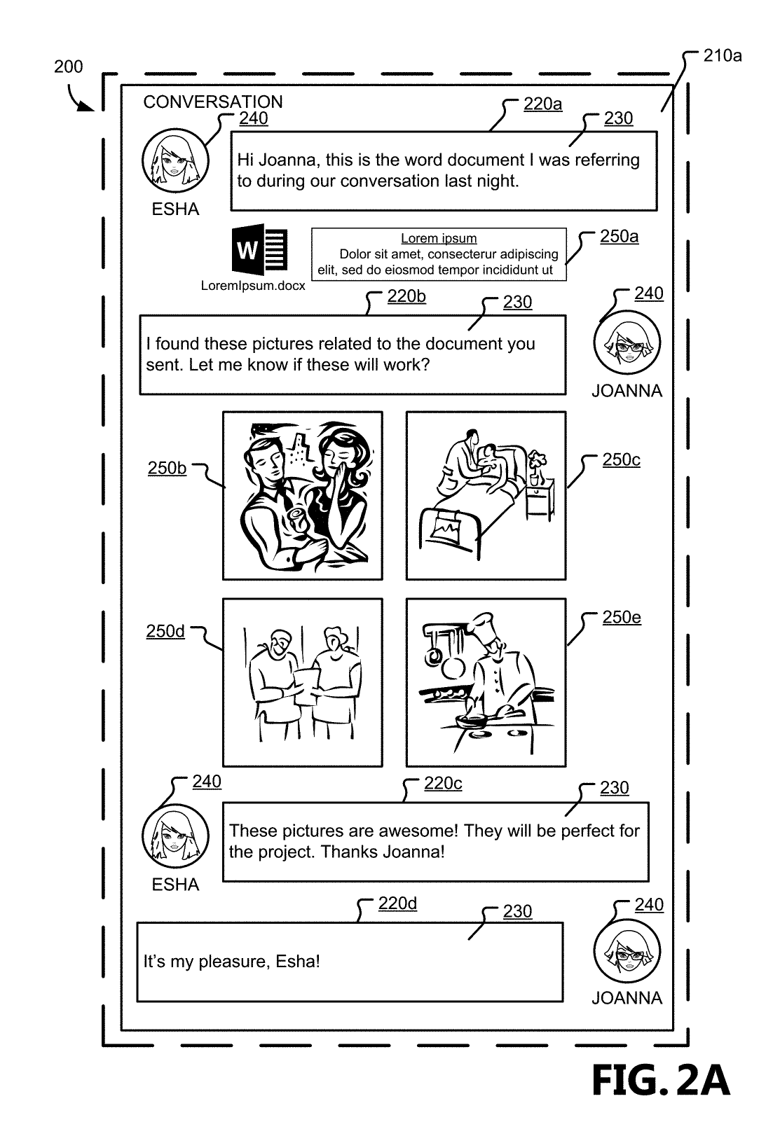

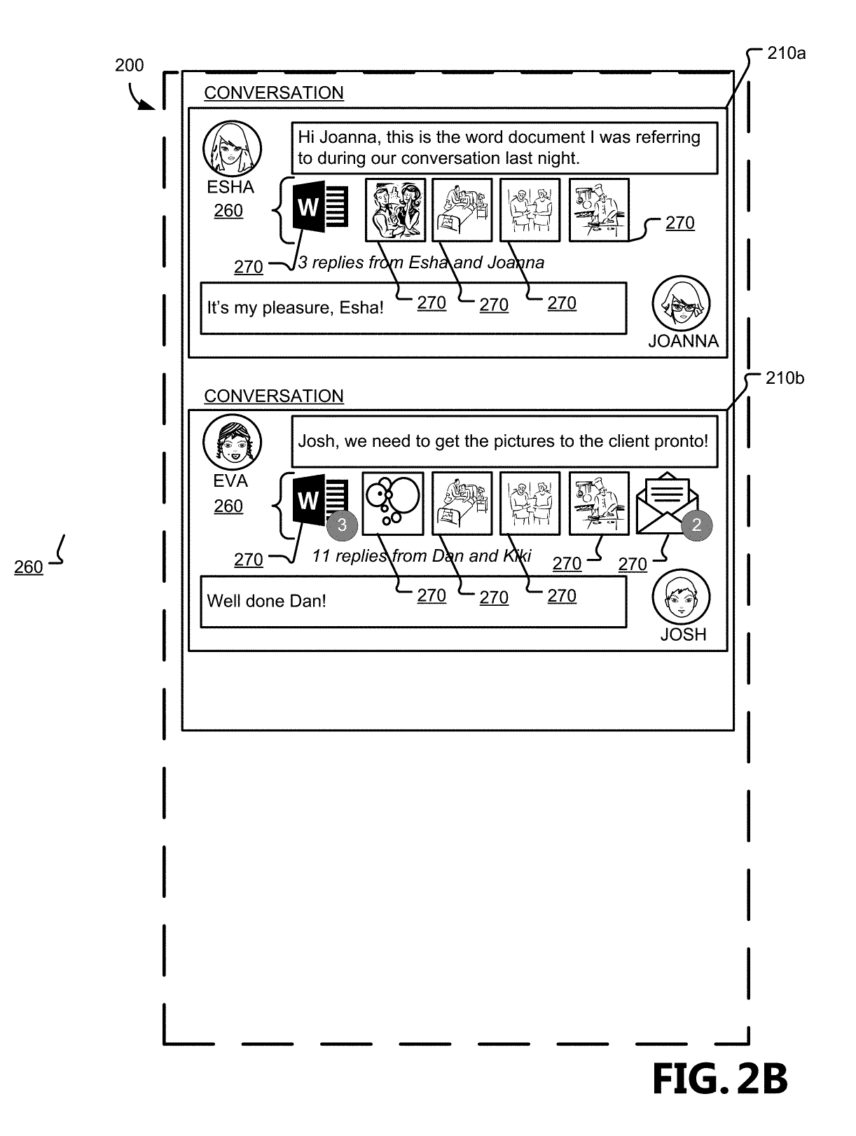

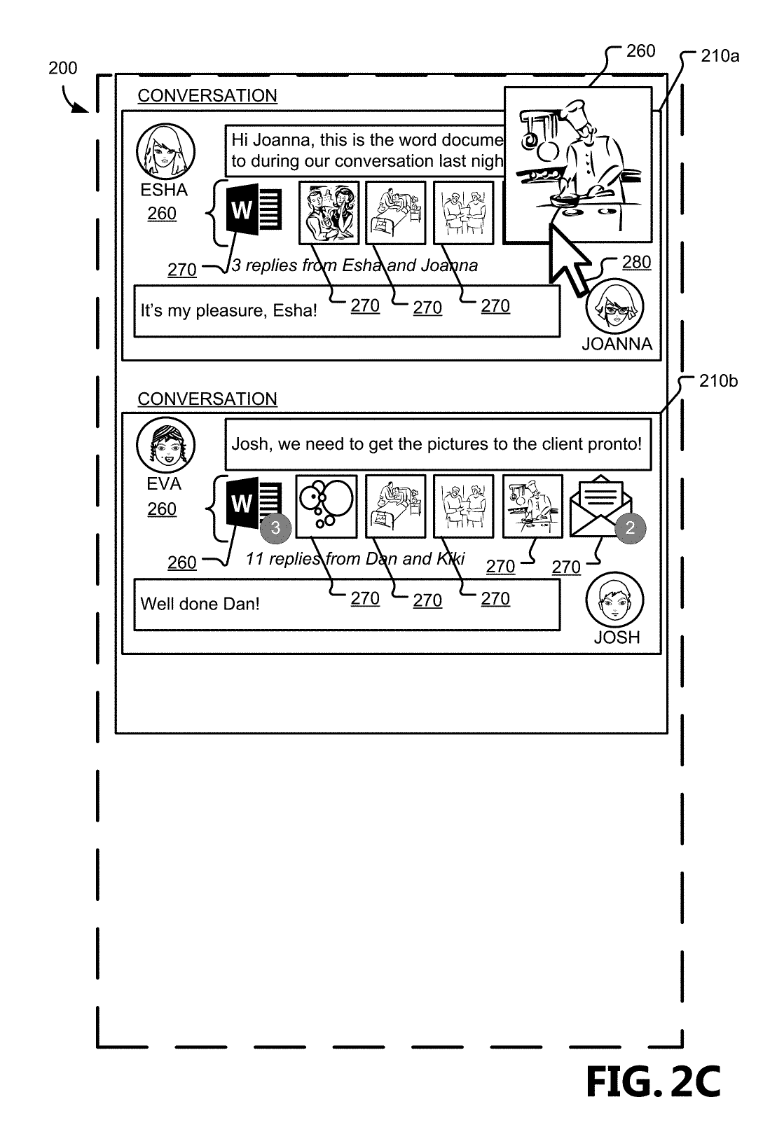

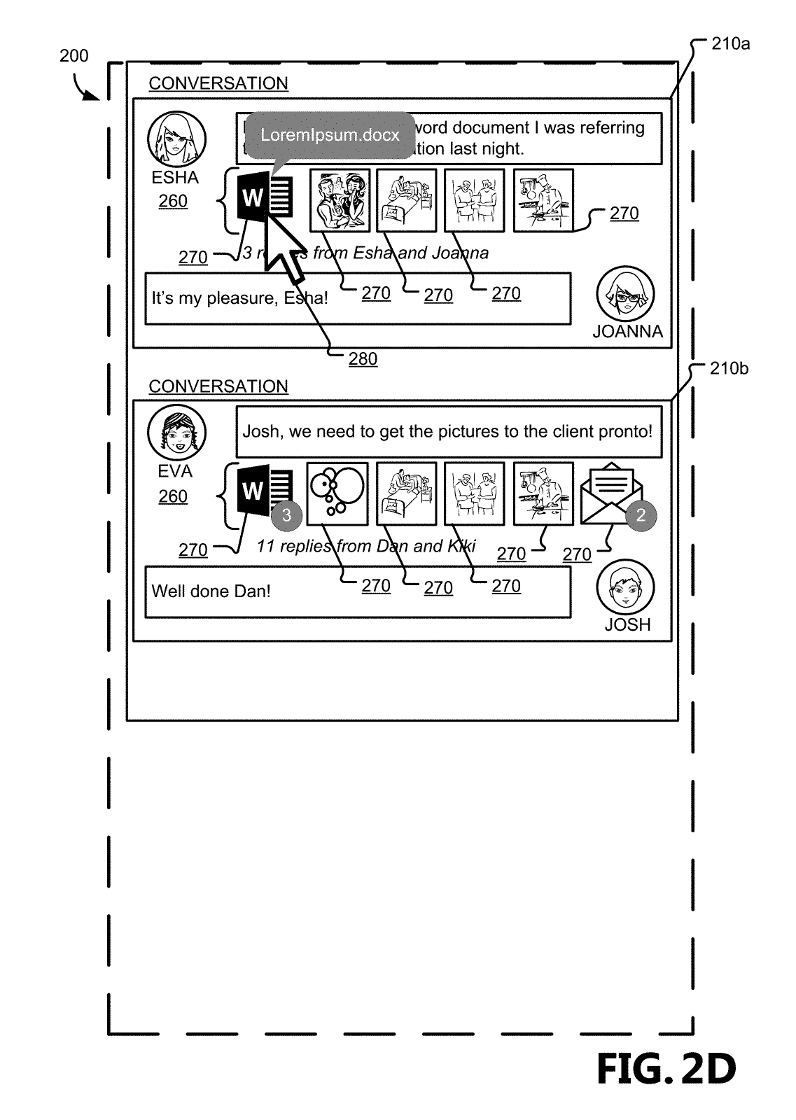

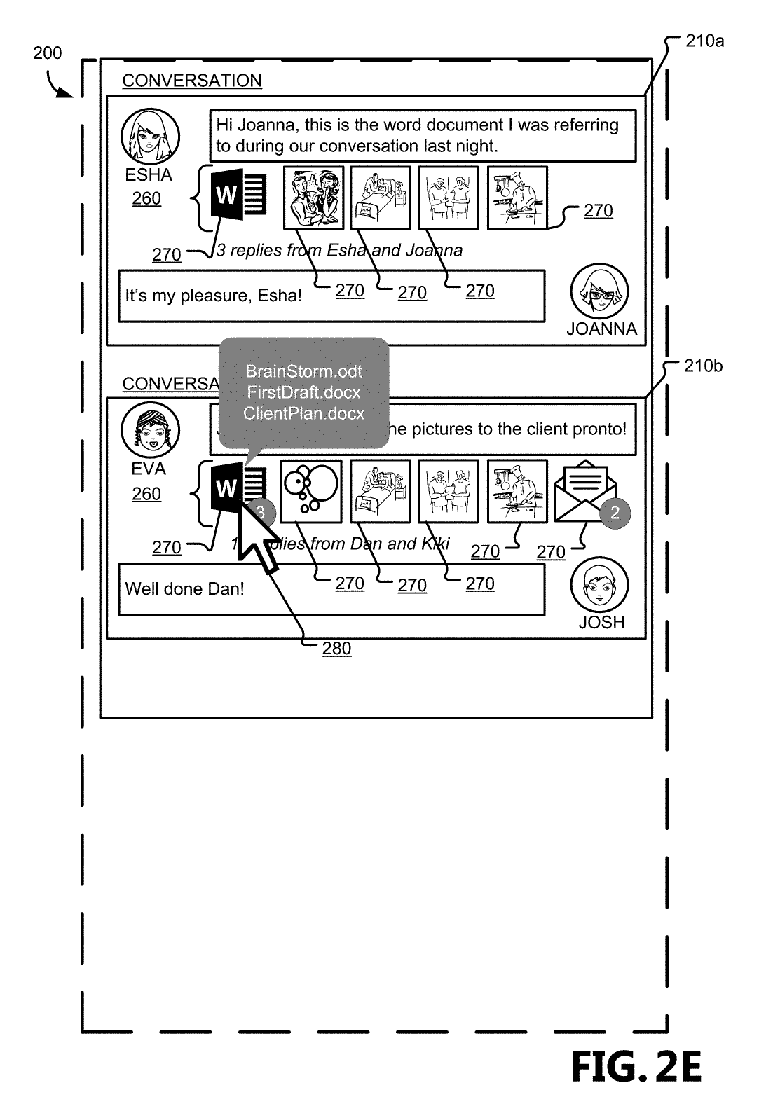

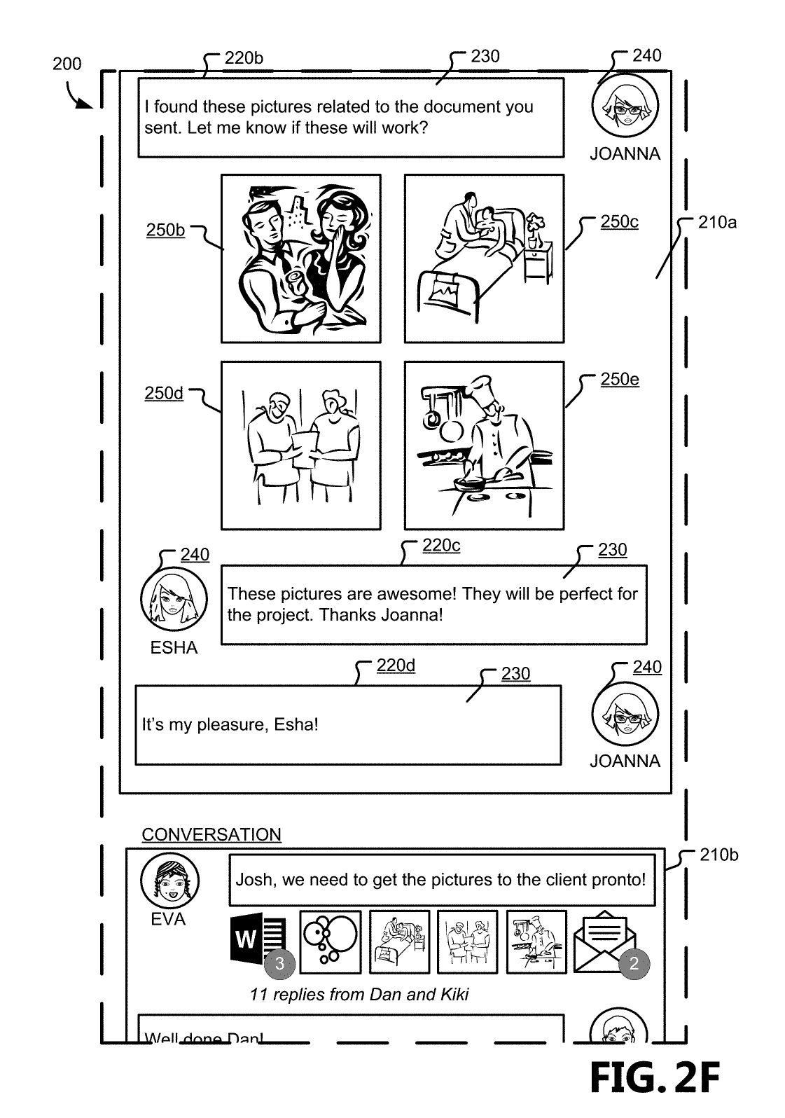

The user device 110 includes a display device on which electronic communications received from the conversation store 120 are displayed. Various example illustrations of conversations are shown in regard to FIGS. 2A-2F. The user device 110 is configured to accept user input to interact with the communications and any associated content item. For example, a user may condense chains of communications to save space on the display device or expand chains of communications to show communications that were hidden in order to save space on the display device. In another example, a user may scroll in a chain of communications to set which communications of the chain are displayed on the display device. The user device 110 is configured to accept a variety of input in a variety of aspects, including, but not limited to: those relying on mice, keyboards, and remote controls, as well as Natural User Interface (NUI) methods, which enable a user to interact with the user device 110 in a “natural” manner, such as via technologies including touch sensitive displays, voice and speech recognition, intention and goal understanding, motion gesture detection using depth cameras, motion gesture detection using accelerometers/gyroscopes, facial recognition, three-dimensional displays, head, eye, and gaze tracking, immersive augmented reality and virtual reality systems.

The communication store 120 represents a computing device or service that stores communications in a chain of a conversation. For example, a series of emails between persons may be stored in the communication store 120 as a conversation. In another example, a series of instant messages for a work group may be stored in the communication store 120. The chain of communications represents the back-and-forth communications between parties over successive related communications. Examples of a communication store include, but are not limited to: email services (such as GMAIL™—available from Alphabet, Inc. of Mountain View, Calif.) group messaging applications (such as SLACK®—available from Slack Techs. Inc., of San Francisco, Calif.), and threaded forums.

The chained communications may be gathered into conversations based on a shared starting message in which responses are directed to the starting message or to an earlier response in the chain that is linked to the starting message. The communication store 120 is configured to provide the conversations to the user device 110 for display thereon and to receive communications to add to an existing conversation or start a new conversation. In various aspects, the communications include a recipient, which may be a person, a bot, or a conversation. For example, a user may include an email address, an instant messenger alias, or specify a conversation thread to direct a communication to the desired persons. The communication store 120 is operable to restrict which conversations and communications are provided to the user device 120 based on the credentials of the associated user and permissions on the communication store 120.

The content store 130 represents a file repository accessible to the communication store 120 and (optionally) by the user device 110. In various aspects, the user may attach one or more files with a communication. For example, a user may attach images, video files, audio files, spreadsheet files, word processing files, presentation files, etc., as attachments to a communication that is part of a conversation. In one aspect, these attachments may be uploaded from a first content store 130 (e.g., a storage device on a first user device 110) to a second content store 130 viable from several receiving user devices 110 (e.g., an online document repository) when a message is submitted, which includes a hyperlink to the attachment in the second content store 130. In another aspect, these attachments may be included in the communications, which the communication store 120 receives from the user device 110 and may store in the content store 130. In various aspects, the content store 130 stores previews of the content items in addition to the content items, which may be included in the conversation to provide a reduced-size (in terms of storage size) version of the content item to users by which to request the associated content item. Examples of a content store 130 include, but are not limited to: online file storage services (such as GOOGLE DRIVE™—available from Alphabet, Inc. of Mountain View, Calif.) image hosting applications (such as IMGUR®—available from Imgur Inc., of San Francisco, Calif.), networked and local hard drives, and document management systems.

FIGS. 2A-2F illustrate example displays of conversation chains. Each of the FIGS. 2A-2F illustrate the user interface 200 of a computing device having a given size represented by the dashed line that displays an example chain of communications undergoing various interactions according to user input to expose content items and surface information about the communications in response. As will be appreciated, FIGS. 2A-2F are given as non-limiting examples to illustrate aspects of the present disclosure; other arrangements of various features than those shown and discussed herein are contemplated by the present disclosure.

In FIG. 2A, a communication chain of a first conversation 210a is shown in its expanded state. Visible in the first conversation 210a (generally, conversation 210) are several messages 220a-d (generally, messages 220), which include a (initial) first message 220a and three replies that are part of the first conversation 210a. Each message 220 is shown including text 230 related to the conversation and an avatar 240 for the person who wrote the associated message 220. In addition to the text 230 of the messages 220, the first message 220a includes a first content item 250a of a word processing document, and the second message 220b includes a second content item 250b, a third content item 250c, a fourth content item 250d, and a fifth content item 250e of image files. In various aspects, the text 230 may include content items as hyperlinks or the text itself may be designated a content item, such as, for example, when the text is selected as of particular importance to the conversation (e.g., a boss lays out a series of requirement to a team).

In FIG. 2B, the first conversation 210a from FIG. 2A and a second conversation 210b are shown in condensed states. In the illustrated condensed states, the initial and final messages 220 of each conversation are displayed, as well as a control interface 260, which is displayed between the initial and final messages 220. As will be evident, by condensing the display of the conversations 210, more conversations 210 may be displayed in a given amount of screen space, thus improving the functionality of the user device 110 to visually convey information to a user regarding various conversations 210.

The control interface 260 includes a plurality of control elements 260 that are associated with the content items 240 identified from the messages 220 of the conversation 210. Although illustrated as being disposed of between the initial and final messages 220 of a condensed communication chain, in other aspects the control interface 250 may be disposed of in other locations, such as, for example, adjacent to a title of an associated conversation 210, adjacent to a reply interface for an associated conversation 210, to the side of the messages 220 displayed for a condensed communication chain, etc.

The order in which the control elements 270 are included in the control interface 270, may differ in various aspects, which may base the order on an order in which the associated content items 240 appear in the conversation 210, similarities between associated content items 240 (e.g., group all control elements 270 of type x together), a size of the associated content item 250, and/or a location at which each associated content item 250 is stored (e.g., first content store 130 versus second content store 130). Each control element 270 is configured to accept user input to enable the exposure of the content item 250 associated with the control element 270 based on the type on user input received. Various example exposures are discussed in greater detail in regard to FIGS. 2C-2F. Control elements 270 may be represented as a file type icon, a thumbnail, or other indicia of the content item 250 associated with the control element 270.

In FIG. 2C, a cursor 280 is shown applying a mouse-over actuation to a control element 270 associated with the exposure of an image content item 250 via a preview. In the illustrated example, a hover or mouse-over is operable to cause the control element 270 to expose its associated content item 250 by generating and/or showing a preview of that content item 250 on the display of the user device 110. For example, an enlarged thumbnail of an image, a clip of an audio/video file, an image of a snippet of a word processor document, an image of a first slide of a presentation document, etc., is shown in response to an actuation associated with previewing the content item 250, such as a hover or mouse-over.

In FIG. 2D, the cursor 280 is shown applying a mouse-click actuation to a control element 270 associated with the exposure of metadata of a content item 250. For example, the name of a file, its author, the last time the file was edited, its filepath, etc., may be exposed via a dialog box associated with the control element 270. In other aspects, different actuation may provide different exposure behaviors. For example, a double-click actuation from the cursor 280 (or a double-tab, a two-finger tap, a given gesture, etc.) may launch an application associated with the content item 250 so that an instance of that content item 250 is provided for manipulation in the application. In another example, a right-click (a command-click, a three-finger tap, a particular gesture, etc.) may provide a save-as dialog for the associated content item 250, enabling a user to save the content item 250 to the user device 110 or another content store 130.

In FIG. 2E, the cursor 280 is shown applying a mouse-click actuation to a control element 260 associated with the exposure of metadata of a plurality of content items 250 associated with one control element 260 that is shared by multiple content items 250. In various aspects, a shared control element 270 displays a number or other indicator (e.g., “+”, “more”, “many”) that it is associated with multiple content items. For example, a control element 270 associated with two content items 250 will display a “2” in association with its icon, whereas a control element 270 associated with three content items 250 will display a “3” in association with its icon.

When actuated, a shared control element 260 is configured to expose information about the multiple content items 250 with which it is associated, and to accept additional user input related to one or more of the associated content items 250. For example, on a first actuation metadata for the multiple content items 250, such as their names, are exposed, and these names may receive subsequent actuation to perform actuations to expose the individual content items 250. For example, individual content items 250 may be jumped to in the conversation 210, saved to the user device 110 or other content store 130, forwarded to a new recipient as part of a message, opened as an instance in an associated application, etc.

In FIG. 2F, an exposure of one of the content items 250 according to a jump in the conversation 210. For example, in response to an actuation of the control element 250 associated with the second content item 250b, the first conversation 210a has been set to an expanded state and scrolled to the second message 220b, from which the second content item 250b has been identified as originating. In various aspects, a condensed chain of communications may be fully expanded and then scrolled to the associated message 220 (as illustrated). In other aspects, the condensed chain of communications may be partially expanded; showing the condensed chain of communications plus the associated message 220 for the content item 250.

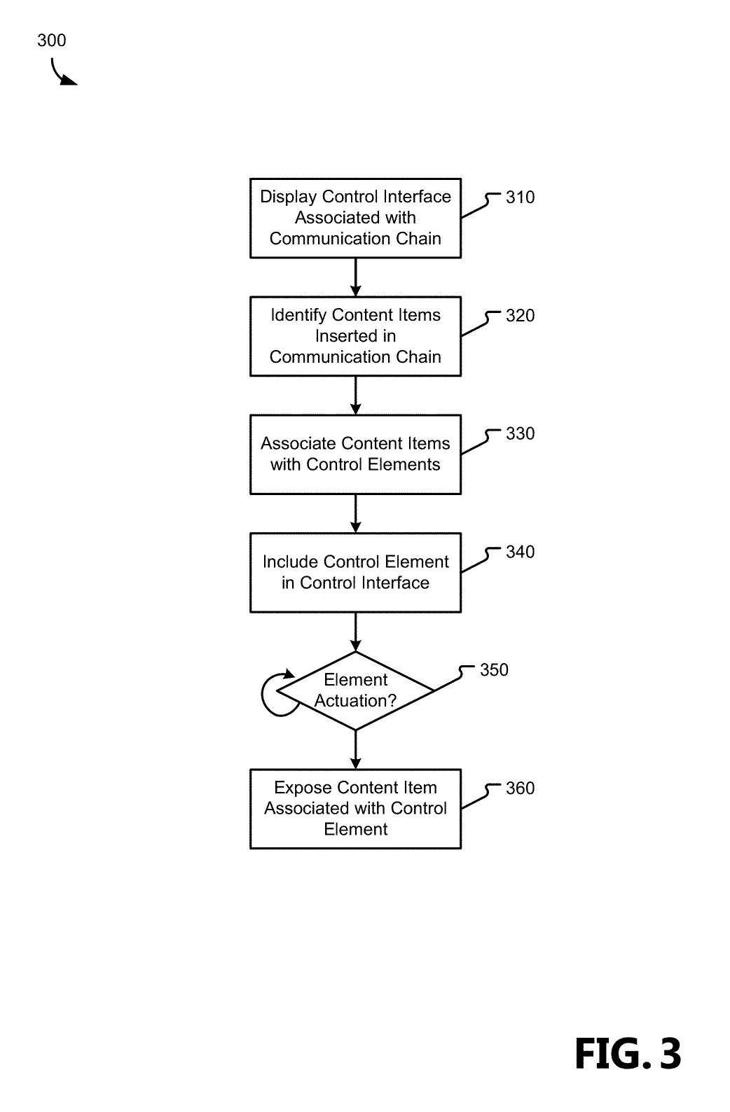

FIG. 3 is a flow chart showing general stages involved in an example method 300 for surfacing details from a condensed chain of communications. Method 300 begins with OPERATION 310, where a control interface is displayed with an associated communication chain on a user device 110. In various aspects, some or all of the communication chain is displayed on the user device (e.g., a communication chain may “hang” off of an edge of a display area that is scrollable), and the communication chain may be displayed in an expanded or a condensed state. When the communication chain is displayed in a condensed state, the control interface is disposed of between the first communication and the last communication of the chain, adjacent to a new reply control, or adjacent to a title of the communication chain.

At OPERATION 320 content items inserted into the communication chain are identified. In various aspects, the content items are included in the communications, attached to the communications, or linked to (e.g., via a hyperlink) via the communications. Content items include external files (e.g., document files, audio files, video files), selected communications, and links to other communication chains or communications thereof. For example, content items may include previously occurring and scheduled meetings, emails, word processor documents, spreadsheet documents, presentation documents, images, audio files, video files, highlighted communications and the like, which may be incorporated with (or attached to) a given communication or linked to by a given communication (e.g., as a hyperlink). The content items that are identified may be classified based on their file types, associated programs used to access the files, storage location, etc. In a first example, with two content items of videos included in a communication chain, those content items may be classified as related based on being videos, or may be classified as different if one is a video on linked-to video service and the other is an attachment. In a second example, two content items of word processing documents may be classified as related based on their shared function, or may be classified as unrelated if they use different file extensions or are opened by different word processing applications.

The content items identified in OPERATION 320 are associated with control elements at OPERATION 330. Control elements include various icons, widgets, thumbnails, and indicia for the content items with which they are associated, and are configured to receive user input to provide a variety of responses related to the associated content items. In some aspects, a control element may be shared by multiple content items due to screen-space limitations, such as, for example, when n content items are identified, but the screen space available for displaying control elements only allows for the display of n−1 control elements. In other aspects, a control element may be shared by multiple content items when those content items are classified as related, such as, for example, all content items of type x share one control element while all content items of type y share a second control element. In various aspects, shared control elements include a count feature—indicating the number of content items that share a given shared control element (e.g., 2, 3, 4 . . . ) or that a plurality of content items are associated with the given shared control element (e.g., “+”, “many”, “more”).

Proceeding to OPERATION 340, the control elements associated with the content items are included in the display of the control interface. In various aspects, the control elements are arranged in the control interface based on an order of the content items in the chain of communications, the content item types, etc.

At DECISION 350 it is determined whether an actuation of a control element has occurred. Various actuations depend on the input devices included in the user device 110, but include several types of actuations that are linked to different behaviors to apply to the control element and associated content asset. For example, a primary actuation (e.g., a left mouse click, a one-finger tap, a first voice command, a first gesture) may perform a different action than a secondary actuation (e.g., a right mouse click, a two-finger tap, a second voice command, a second gesture), than a tertiary actuation (e.g., a double left-click, a one-finger press, a third voice command, a third gesture), etc. Whether an actuation is received or not, method 300 may remain at decision 350 to receive additional actuations.

In response to detecting an actuation of a control element at DECISION 350, the content item associated with the actuated control element is exposed OPERATION 360 according to the actuation type and/or the content item type. One of ordinary skill in the art will appreciate various assignments of actuation types to exposure types that may take into account the input hardware of the user device 110, operating system norms for the user device 110, and the context in which those actuations are received.

In a first example, the content item is exposed by navigating to the communication from which the content item was identified (e.g., expanding a condensed communication chain, scrolling an expanded state communication chain to the given communication). In a second example, the content item is exposed by launching a productivity application and an instance of the content item for manipulation in that application. In a third example, the content item is exposed by generating and displaying a preview of the content item (e.g., an image of a text snippet from a word processing document, an image of a first slide from a presentation document, an enlarged thumbnail of an image). In a fourth example, a file interface is generated for the content item (e.g., displaying a file name, displaying save-as options for the content item, displaying content item metadata (author, creation date, last edit, file location, etc.)).

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 4-5B and the associated descriptions provide a discussion of a variety of operating environments in which examples are practiced. However, the devices and systems illustrated and discussed with respect to FIGS. 4-5B are for purposes of example and illustration and are not limiting of a vast number of computing device configurations that are utilized for practicing aspects, described herein.

FIG. 4 is a block diagram illustrating physical components (i.e., hardware) of a computing device 400 with which examples of the present disclosure may be practiced. In a basic configuration, the computing device 400 includes at least one processing unit 402 and a system memory 404. According to an aspect, depending on the configuration and type of computing device, the system memory 404 comprises, but is not limited to, volatile storage (e.g., random access memory), non-volatile storage (e.g., read-only memory), flash memory, or any combination of such memories. According to an aspect, the system memory 404 includes an operating system 405 and one or more program modules 406 suitable for running software applications 450. According to an aspect, the system memory 404 includes various instructions that are executable by the processing unit 402. The operating system 405, for example, is suitable for controlling the operation of the computing device 400. Furthermore, aspects are practiced in conjunction with a graphics library, other operating systems, or any other application program, and are not limited to any particular application or system. This basic configuration is illustrated in FIG. 4 by those components within a dashed line 408. According to an aspect, the computing device 400 has additional features or functionality. For example, according to an aspect, the computing device 400 includes additional data storage devices (removable and/or non-removable) such as, for example, magnetic disks, optical disks, or tape. Such additional storage is illustrated in FIG. 4 by a removable storage device 409 and a non-removable storage device 410.

As stated above, according to an aspect, a number of program modules and data files are stored in the system memory 404. While executing on the processing unit 402, the program modules 406 perform processes including, but not limited to, one or more of the stages of the method 300 illustrated in FIG. 3. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, the computing device 400 has one or more input device(s) 412 such as a keyboard, a mouse, a pen, a sound input device, a touch input device, etc. The output device(s) 414 such as a display, speakers, a printer, etc. are also included according to an aspect. The aforementioned devices are examples and others may be used. According to an aspect, the computing device 400 includes one or more communication connections 416 allowing communications with other computing devices 418. Examples of suitable communication connections 416 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. According to an aspect, any such computer storage media is part of the computing device 400. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

FIGS. 5A and 5B illustrate a mobile computing device 500, for example, a mobile telephone, a smart phone, a tablet personal computer, a laptop computer, and the like, with which aspects may be practiced. With reference to FIG. 5A, an example of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. According to an aspect, the display 505 of the mobile computing device 500 functions as an input device (e.g., a touch screen display). If included, an optional side input element 515 allows further user input. According to an aspect, the side input element 515 is a rotary switch, a button, or any other type of manual input element. In alternative examples, mobile computing device 500 incorporates more or fewer input elements. For example, the display 505 may not be a touch screen in some examples. In alternative examples, the mobile computing device 500 is a portable phone system, such as a cellular phone. According to an aspect, the mobile computing device 500 includes an optional keypad 535. According to an aspect, the optional keypad 535 is a physical keypad. According to another aspect, the optional keypad 535 is a “soft” keypad generated on the touch screen display. In various aspects, the output elements include the display 505 for showing a graphical user interface (GUI), a visual indicator 520 (e.g., a light emitting diode), and/or an audio transducer 525 (e.g., a speaker). In some examples, the mobile computing device 500 incorporates a vibration transducer for providing the user with tactile feedback. In yet another example, the mobile computing device 500 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 500 incorporates peripheral device port 540, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one example of a mobile computing device. That is, the mobile computing device 500 incorporates a system (i.e., an architecture) 502 to implement some examples. In one example, the system 502 is implemented as a “smart phone” capable of running one or more applications (e.g., browser, e-mail, calendaring, contact managers, messaging clients, games, and media clients/players). In some examples, the system 502 is integrated as a computing device, such as an integrated personal digital assistant (PDA) and wireless phone.

According to an aspect, one or more application programs 550 are loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 is used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

According to an aspect, the system 502 has a power supply 570, which is implemented as one or more batteries. According to an aspect, the power supply 570 further includes an external power source, such as an AC adapter or a powered docking cradle that supplements or recharges the batteries.

According to an aspect, the system 502 includes a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 550 via the operating system 564, and vice versa.

According to an aspect, the visual indicator 520 is used to provide visual notifications and/or an audio interface 574 is used for producing audible notifications via the audio transducer 525. In the illustrated example, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. According to an aspect, the system 502 further includes a video interface 576 that enables an operation of an on-board camera 530 to record still images, video stream, and the like.

According to an aspect, a mobile computing device 500 implementing the system 502 has additional features or functionality. For example, the mobile computing device 500 includes additional data storage devices (removable and/or non-removable) such as, magnetic disks, optical disks, or tape. Such additional storage is illustrated in FIG. 5B by the non-volatile storage area 568.

According to an aspect, data/information generated or captured by the mobile computing device 500 and stored via the system 502 are stored locally on the mobile computing device 500, as described above. According to another aspect, the data are stored on any number of storage media that are accessible by the device via the radio 572 or via a wired connection between the mobile computing device 500 and a separate computing device associated with the mobile computing device 500, for example, a server computer in a distributed computing network, such as the Internet. As should be appreciated such data/information are accessible via the mobile computing device 500 via the radio 572 or via a distributed computing network. Similarly, according to an aspect, such data/information are readily transferred between computing devices for storage and use according to well-known data/information transfer and storage means, including electronic mail and collaborative data/information sharing systems.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A method for surfacing details from a condensed chain of communications, the condensed chain of communications including a plurality of communications condensed displayed in a user interface, comprising:
identifying a content item inserted in a given communication of the condensed chain of communications;
displaying a control interface in the user interface, wherein the control interface is displayed in association with the condensed chain of communications and includes a control element associated with the content item; and
in response to receiving an actuation of the control element, exposing the content item.

2. The method of claim 1, wherein exposing the content item includes opening an instance of the content item in a productivity application.

3. The method of claim 1, wherein exposing the content item includes:
expanding the condensed chain of communications; and
scrolling the chain of communications to display the given communication and the content item.

4. The method of claim 1, further comprising:
in response to receiving a secondary actuation of the control element, saving the content item to a selected location.

5. The method of claim 1, further comprising:
in response to receiving a hover action in regard to the control element, displaying a preview of the content item.

6. The method of claim 1, wherein in response to identifying multiple content items in the condensed chain of communications, providing a plurality of control elements in the control interface.

7. The method of claim 6, wherein the multiple content items identified include a plurality of content item types, and wherein each content item type is provided with a different appearance for an associated control element provided in the control interface.

8. The method of claim 7, wherein the plurality of content item types includes:
a word processor file;
a presentation file;
a spreadsheet file;
an image file;
a video file;
a sound file;
an email file; and
a selected communication of the condensed chain of communications.

9. The method of claim 7, wherein a plurality of the multiple content items share a given content item type of the plurality of content item types, a condensed icon for the given content item type represents the plurality of the multiple content items in the control interface.

10. The method of claim 6, wherein the plurality of control elements are provided in the control interface according to an order of the multiple content items in the condensed chain of communications.

11. A system for surfacing details from a condensed chain of communications, the condensed chain of communications displayed in a user interface, comprising:
a processor; and
a memory storage device, including instructions that when executed by the processor are operable to:
identify content items inserted in the condensed chain of communications;
display, in the user interface, a control interface in association with the condensed chain of communications;
for each of the content items identified, display, in the control interface, a control element associated with a given content item of the content items; and
in response to receiving an actuation of a given control element, expose the given content item associated with the given control element.

12. The system of claim 11, wherein to expose the content item the system is further configured to:
open an instance of the content item in a productivity application.

13. The system of claim 11, wherein to expose the content item the system is further configured to:
expand the condensed chain of communications; and
scroll the chain of communications to display the given communication and the content item.

14. The system of claim 11, further configured to:
in response to receiving a secondary actuation of the control element, save the content item to a selected location.

15. The system of claim 11, wherein the content items identified include a plurality of content item types, and wherein each content item type is provided an associated control element provided in the control interface with a different appearance.

16. The system of claim 15, wherein a plurality of the content items share a given content item type of the plurality of content item types, a condensed icon for the given content item type represents the plurality of the content items in the control interface.

17. A computer readable storage device including instructions that when executed by a processor surface details from a condensed conversation displayed on a computing device, wherein the instructions comprise:
displaying, on the computing device, a control interface in association with the condensed conversation;
identifying content items included in the condensed conversation; and
in response to identifying a content item:
associating the content item with a control element, wherein the control element is configured to receive user input from the computing device and in response to the user input, expose the content item on the computing device; and
displaying the control element in the control interface.

18. The computer readable storage device of claim 17, wherein the user input includes:
a mouse input;
touchscreen input;
keyboard input;
positional hover input; and
gesture input.

19. The computer readable storage device of claim 17, wherein exposing the content item on the computing device includes at least one of:
providing a file save interface for the content item;
launching an application associated with the content item; and
expanding the condensed conversation for display on the computing device, and scrolling to a communication of the condensed conversation from which the content item was identified.

20. The computer readable storage device of claim 17, wherein a plurality of the content items identified share a content type, the control element to which the content items of the plurality are associated is a shared control element for the content type.
